(19) United States
(12) Patent Application Publication
(10) Pub. No.: US 2007/0021976 A1
(43) Pub. Date: Jan. 25, 2007

(54) Apparatus and method for determining the health effects associated with various products

(76) Inventors: Yu Zong Chen, Singapore (SG); Peter Saunders, Singapore (SG); Zhi Wei Cao, Singapore (SG)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 10/575,602

(22) PCT Filed: Oct. 15, 2004
(86) PCT No.: PCT/SG04/00340

§ 371 Date: Apr. 13, 2006

Related U.S. Application Data
(60) Provisional application No. 60/512,479, filed on Oct. 17, 2003.

(51) Int. Cl. G06Q 50/00

(52) U.S. Cl. 705/2

(57) ABSTRACT

There is provided an apparatus and method for determining health effect of a selected product, or products(s) providing a selected health effect. The apparatus comprises a database of products and associated health effects; an input for a user to input the selected product or selected health effect; a processor for determining health effect of the selected product from the database and/or for determining product(s) from the database providing the selected health effect; and an output for outputting information to the user. The method comprises the steps of providing a database of products and associated health effects; inputting the selected product or selected health effect into a user input; determining health effect of the selected product from the database, or product(s) from the database providing the selected health effect; and outputting information to the user.

The present invention relates to an apparatus and method for determining health effect of a selected product, or products(s) providing a selected health effect. Particularly, but not exclusively, the invention relates to an apparatus and method for determining the synergistic and counterproductive health effects of various products when combined with other products.

Many fruits, vegetables and other foodstuffs have been shown to contain chemicals with effects beneficial to health. Those beneficial health effects include prevention of common cancers, cardiovascular diseases and heart diseases, anti-oxidation or anti-ageing effects, the maintenance of healthy prostate function, the stimulation of the immune system, decrease in platelet aggregation, alteration in cholesterol metabolism and reduction in blood pressure. Such effects have been well-documented¹.

In addition, medicinal herbs and herbal products have long been used in traditional medicines across the world, particularly in China and India, where traditional medicines still form a large part of overall health care². Non-prescription herbs and herbal products are increasingly being used, for their beneficial therapeutic and health effects in other societies too. It is well known that the use of such herbs and herbal products is on the increase in the United States and Europe, for example³.

It is known that the beneficial effects of foodstuffs (including botanical products and herbal products) are provided by one or more of their biologically active constituent chemicals⁴. However, recent statistics⁵ have shown that, in the general public, there is an insufficient intake of specific fruits, vegetables and other foodstuffs. Consequently, in many people, the beneficial effects of such foodstuffs are not being seen.

In general, there is a lack of knowledge regarding the specific beneficial health effects of most foodstuffs (including herbal and botanical products). There is also a lack of knowledge regarding the quantity of the foodstuffs required to produce those effects. For the small number of consumers who know the beneficial effect of a specific product, the quantity to be consumed is often left to their own discretion. Thus, many consumers will have either insufficient intake (and will, consequently, not receive the expected beneficial health effect) or will have excessive intake (which is economically and resourcefully wasteful and may put the consumer at risk, because some foodstuffs contain levels of potentially toxic substances and large doses may also provoke harmful herb-drug interactions). The possible risks to consumers due to consumption of an incorrect quantity of various products are known⁶ and the median effective dose of a large number of biologically active chemicals has been researched and experimentally measured⁷. In fact, there are currently more than 2000 biologically active chemicals with median effective dose information available. In addition, there is median effective dose information available for a variety of medicinal herbal ingredients⁸.

So, consumption of sufficient levels of the constituent chemicals is required to achieve an expected beneficial health effect⁹. The quantity of each constituent biologically active chemical in a foodstuff (including a botanical or herbal product) can be experimentally measured and it is often termed the “content” and given in terms of the percentage weight of the chemical with respect to the total weight of the foodstuff. The contents of constituent chemicals in a variety of fruits, vegetables, foodstuffs of other categories, botanicals, and herbal products (including over 50 fruits, over 40 vegetables and over 2500 herbs and herbal products) have been experimentally measured¹⁰.

Thus, the consumption quantity of a particular foodstuff required to produce a specific beneficial health effect can be derived from the experimentally measured content(s) of the related biological chemical(s) in the foodstuff together with the experimentally measured median effective dose(s) of those chemical(s).

In addition, there have been reports¹¹ that the total content of foodstuffs (including herbal and botanical products) shows a significantly better effect than an equivalent dose of an isolated active compound. In addition, some herbal combinations are known to be more effective than use of their constituent herbs separately¹². These findings suggest that it is possible for some of the foodstuffs and herbs to exert their therapeutic effects by synergistic actions of their active ingredients. This is further evidenced by observations that positive beliefs about alternative medicines are not necessarily associated with their positive or negative effects¹³. Conversely, certain combinations of foodstuffs and herbs are known to be counterproductive and there may also be unwanted herb-drug and food-drug interactions¹⁴.

The synergistic effect or unwanted counterproductive effect of foodstuff, herb and herb-drug combinations is produced by a group of active ingredients in them. Knowledge of molecular interactions has recently been used in several studies for explaining the synergistic effects of herbal ingredients¹⁵. For instance, some ingredients in St. John's wort have been found to separately inhibit CMPT, monoamine receptor and monoamine reuptake, but their concentrations in St. John's wort are at levels that they are individually sub-therapeutic for depression. However, these ingredients have been found to combine to produce a pharmacodynamic synergy that contributes to the observed anti-depression effects from this herb¹⁶. In another example, an ingredient in chaulmoogra oil has been found to potentiate the antimicrobial action of berberine in berberis plants by enhancing its bioavailability via inhibition of the berberine-removing multidrug pump¹⁷. This is a typical case of pharmacokinetic synergy between two herbal ingredients.

These studies raise an interesting question about the possibility of using the literature-described molecular interaction profiles of the ingredients for providing the synergistic or counterproductive effects in various foodstuffs and herbs and their combinations. Such an approach requires the availability of the relevant information for a sufficient number and variety of foodstuffs, herbs and herbal ingredients. Literature currently available contains information about experimentally indicated molecular interactions for more than 1,800 active ingredients from more than 1,200 foodstuffs and herbs. Overall, these ingredients are known to interact with at least 970 distinct proteins many of which are therapeutic, toxicological and pharmacokinetic related proteins.

Thus, although information on the beneficial health effects of various products exists, consumers are currently unable to determine which product they should take to provide a particular beneficial health effect, or how much of it they should take to provide that effect. Also, they are currently unable to determine whether they should avoid combining it with another product (because that combination will provide an unwanted counterproductive effect) or whether they should, in fact, combine it with another product (because that combination will provide a synergistic effect).

It is an object of the invention to provide an apparatus and method which allows a user to determine health effects associated with various products, together with the daily consumption quantities of products required to produce the health effect and other useful information. It is a further object of the invention to provide an apparatus and method which allows a user to determine the synergistic and counterproductive health effects associated with a particular product when combined with one or more other products.

According to the invention, there is provided apparatus for determining health effect of a selected product, or products(s) providing a selected health effect, the apparatus comprising: a database of products and associated health effects; an input for a user to input the selected product or selected health effect; a processor for determining health effect of the selected product from the database and/or for determining product(s) from the database providing the selected health effect; and an output for outputting information to the user.

Thus, the user is able to input either a selected product or a selected health effect and the output provides information to the user regarding the health effect of the selected product, or the product or product(s) providing the selected health effect.

In an embodiment of the invention, the apparatus further comprises weighing scales connected to the input, for weighing the selected product. The weighing scales may comprise a user display connected to the output. In an embodiment of the invention, the apparatus further comprises a barcode scanner connected to the input, for scanning a barcode of the selected product.

Including weighing scales and/or a barcode scanner in the apparatus is useful because, currently, many retailers and related manufacturers use an automated system to register their products and to display or generate product information (such as price) on various information media (such as a price tag or a brochure). (The term “retailers” includes but is not limited to supermarkets, food stores, botanical stores, herbal product stores and drug stores.) Weighing devices and barcode scanners may easily be connected into such an automated system to allow the consumer to know how much of a particular product he is purchasing and to allow the retailer to keep an accurate stock take.

It is envisaged that the user may use the weighing scales to weigh a particular product. The product name may be inputted by the user and the weight of the product may be fed directly to the input. Then, the output can provide information to the user regarding the health effect of the product and whether the amount of product provided is sufficient to provide the stated health effect. This arrangement also provides a convenient platform for selling, distributing, and purchasing products which provide a health effect.

Similarly, it is envisaged that the user may use the barcode scanner to input information on a particular product directly to the input. The product barcode may provide information on all details of the product (without the user being required to input any further information). Then, the output can provide information to the user regarding the health effect of the product and whether the amount of product provided is sufficient to provide the stated health effect.

Preferably, the database comprises information on the daily consumption quantity (DCQ) of some or all of the products in the database, required to produce the health effect. The DCQ is the quantity of the product in grams that is required daily to produce a given health effect. Alternatively, the apparatus may comprise a further database comprising this information.

In a particularly advantageous embodiment, the database comprises information on synergistic effects of some or all the products in the database, when combined with another product or products. Alternatively, the apparatus may comprise a further database comprising this information. In addition, or instead, the database may comprise information on counterproductive effects of some or all the products in the database, when combined with another product or products. Alternatively, the apparatus may comprise a further database comprising this information.

Thus, in the embodiment described above, the user is able to input a selected product, for example, and the output will provide information regarding the health effect of the selected product along with information on the synergistic effect and/or counterproductive effect of the product when combined with another product or product(s). Alternatively, the user is able to input a selected health effect, for example, and the output will provide information regarding the product or product(s) which provide that health effect and the synergistic and/or counterproductive effect of that product when combined with another product or product(s). Thus, the user is able to avoid counterproductive combinations and the most efficient DCQ may be derived given information on synergistic effects of various product combinations.

Preferably, the database comprises the price of some or all the products in the database. Alternatively, the apparatus may comprise a further database comprising that information. That information may be loaded by a retailer or manufacturer. Thus, in this case, the user is able to determine, for example, the cost of various products which provide a selected health effect. Thus, the user may be able to choose the most economic way to achieve the selected health effect.

Optionally, the database comprises information on the biologically active chemical or chemicals producing the health effect in some or all the products in the database. Alternatively, the apparatus may comprise a further database comprising this information. Optionally, the database comprises information on the CAS number of biologically active chemical(s) in the products. Alternatively, the apparatus may comprise a further database comprising this information. In these cases, the input may be suitable for a user to input the chemical name of a particular chemical and/or for a user to input the CAS number of a particular chemical.

Optionally, the database comprises information on the content of biologically active chemical(s) in each product. Alternatively, the apparatus may comprise a further database comprising this information.

In an embodiment of the invention, the processor is a computer. In that case, preferably, the database is stored on a storage device for use with the computer. Alternatively, the database may be stored on the computer hard drive. The computer may be a host computer.

The input may be a computer user interface. The output may also be a computer user interface. The input may be a user interface of a user computer. The output may be a user interface of a user computer.

According to the invention, there is further provided apparatus for determining health effect of a selected product, or products(s) providing a selected health effect and synergistic and/or counterproductive effects of combining one or more products, the apparatus comprising: 1) a database of products and associated health effects and effects of combining products in the database with one or more other products; 2) an input for a user to input a selected product or selected health effect; 3) a processor for determining health effect of the selected product from the database and synergistic and/or counterproductive effects associated with the selected product and/or for determining product(s) from the database providing the selected health effect and synergistic and/or counterproductive effects associated with that product(s); and 4) an output for outputting information to the user.

According to the invention, there is also provided a method for determining health effect of a selected product, or products(s) providing a selected health effect, the method comprising the steps of: providing a database of products and associated health effects; inputting the selected product or selected health effect into a user input; determining health effect of the selected product from the database, or product(s) from the database providing the selected health effect; and outputting information to a user.

Thus, a user inputs either a selected product or a selected health effect and the information regarding the health effect of the selected product, or the product or product(s) providing the selected health effect is outputted to the user.

In an embodiment of the invention, the step of inputting comprises selecting the product or health effect from a predetermined list. In an embodiment of the invention, the step of inputting comprises typing the health effect or product name.

In an embodiment of the invention, the step of inputting the product comprises scanning a product barcode. In an embodiment of the invention, the step of inputting comprises inputting the weight of a product. Inputting the weight of a product may be via weighing scales connected to the input.

The step of inputting the product may comprise inputting a chemical name. The step of inputting the product may comprise inputting a chemical CAS number. The step of inputting the product may comprise inputting information on the source of the product. For example, the location of growth of the product may be inputted or the time of harvest/collection may be inputted.

Of course, it is possible for the step of inputting to comprise a combination of inputting types. For example, the user may type part of a product name and the correct name will be selected from a product list as the user types. Or, the weight of the product may be inputted via weighing scales while the user selects the product name from a selection. Other combinations are also envisaged.

The step of outputting the information to the user may comprise outputting the information on an electronic display on the weighing scales.

The step of providing a database of products and associated health effects, may comprise providing a database including information on the daily consumption quantity for some or all of the products in the database, required to produce the health effect.

The step of providing a database of products and associated health effects, may comprise providing a database including information on synergistic effects of some or all the products in the database, when combined with another product or products.

The step of providing a database of products and associated health effects, may comprise providing a database including information on counterproductive effects of some or all the products in the database, when combined with another product or products.

The step of providing a database of products and associated health effects, may comprise providing a database including the price of some or all the products in the database.

The step of providing a database of products and associated health effects, may comprise providing a database including information on the biologically active chemical or chemicals producing the health effect in some or all the products in the database.

The step of providing a database of products and associated health effects, may comprise providing a database including information on the CAS number of biologically active chemical(s) in the products.

The step of providing a database of products and associated health effects, may comprise providing a database including information on the content of biologically active chemical(s) in each product.

According to the invention, there is further provided a method of generating a database of products and associated health effects, comprising the steps of:
a) providing a first database of products and the contents of biologically active chemicals in those products;
b) providing a second database of biologically active chemicals and median effective doses of those chemicals required to provide particular health effects;
c) selecting a product P from the first database;
d) from the first database, determining a biologically active chemical B in product P and the content C of biologically active chemical B in product P;
e) from the second database, determining the median effective dose D of biologically active chemical B to provide a particular health effect H;
f) determining the daily consumption quantity DCQ of product P required to provide health effect H, from the results at steps d) and e);
g) inputting product P, daily consumption quantity DCQ, biologically active chemical B, content C, median effective dose D and health effect H into a third database; and
h) repeating one or more of steps c) to g).

According to the invention, there is further provided a method for determining health effect of a selected product, or products(s) providing a selected health effect, the method comprising the steps of:
user computer means receiving an input on the selected product or selected health effect;
host computer means determining, from a database of products and associated health effects, health effect of the selected product, or product(s) providing the selected health effect; and
user computer means outputting information to a user.

It should be noted that, throughout the specification, where the term “product” is used, this term should be construed to include food products, herbs, herbals products, botanicals, botanical products, drugs, biologically active chemicals contained within foodstuffs, and any other products which may be ingested. In addition, where the term “health effect” is used, this should be construed to be a positive or negative medical, therapeutic or health effect and where the term “beneficial health effect” is used, this should be construed to be a positive medical, therapeutic or health effect. Throughout the specification, the term DCQ is used for Daily Consumption Quantity i.e. the amount in grams of a particular product required each day to produce a particular health effect.

An embodiment of the invention will now be described with reference to the following figures, meant as illustrative examples only, of which

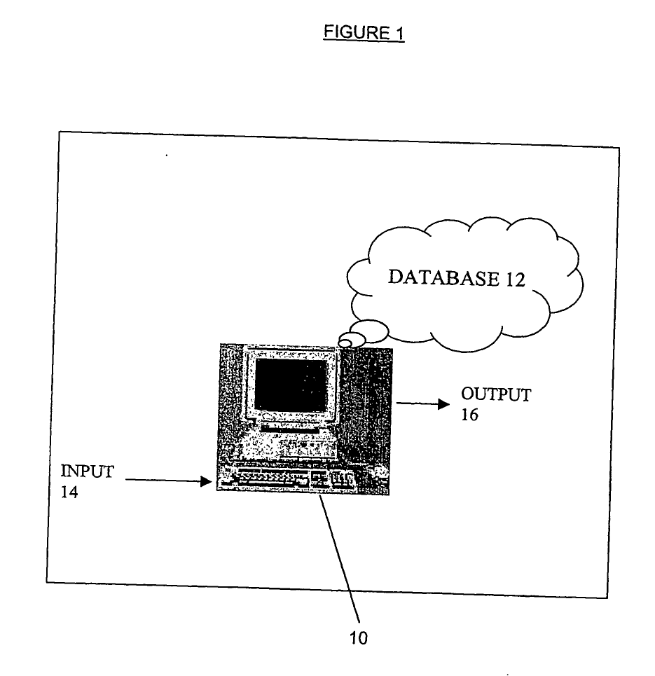

FIG. 1 is a schematic illustration of apparatus on which the method of the invention may be implemented;

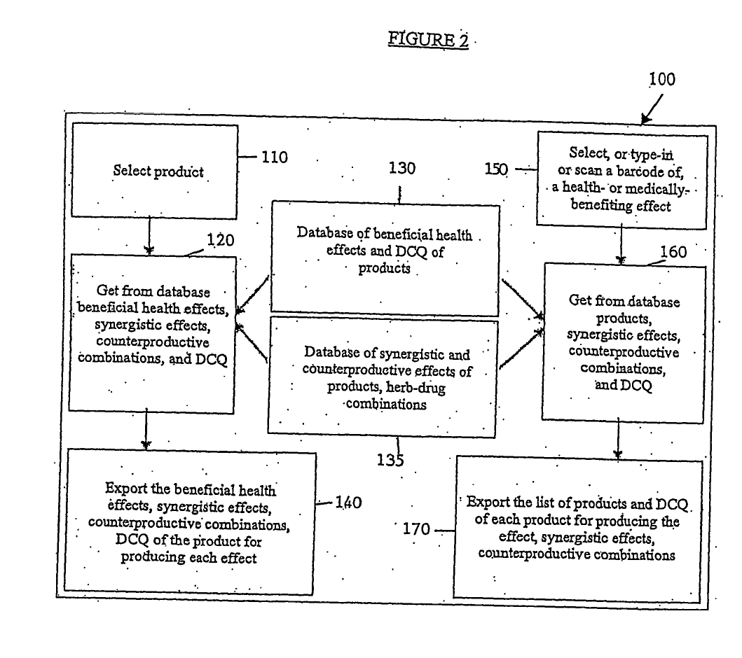

FIG. 2 is a flow chart showing generally how a user may obtain beneficial effects, DCQs and synergistic/counterproductive information for a selected product or obtain product information, DCQs and synergistic/counterproductive information for a selected beneficial effect;

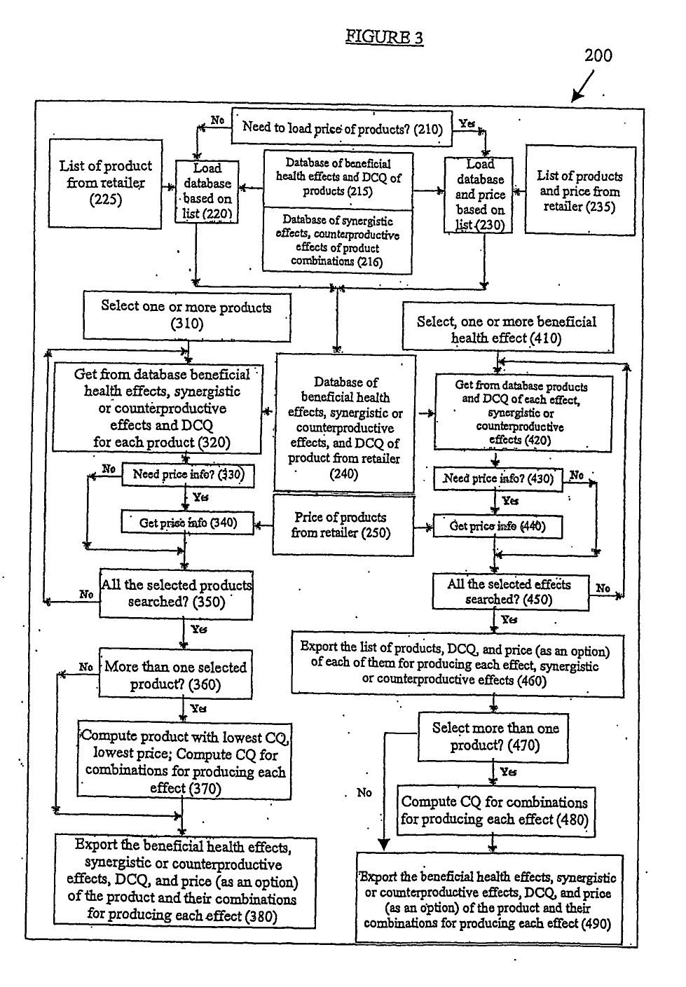

FIG. 3 is a flow chart showing a method for determining the beneficial effect of a particular product or for determining the product or products required to produce a particular beneficial effect together with price information relating to the products;

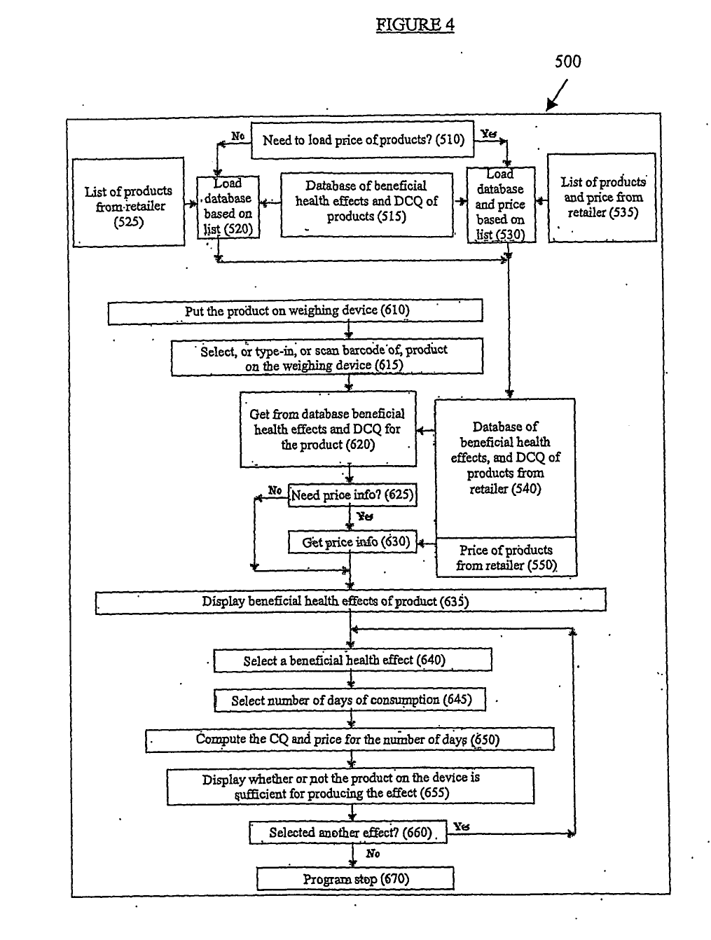

FIG. 4 is a flow chart showing a method enabling use of a weighing device to display information on whether or not a product on the device is sufficient to produce a particular beneficial health effect;

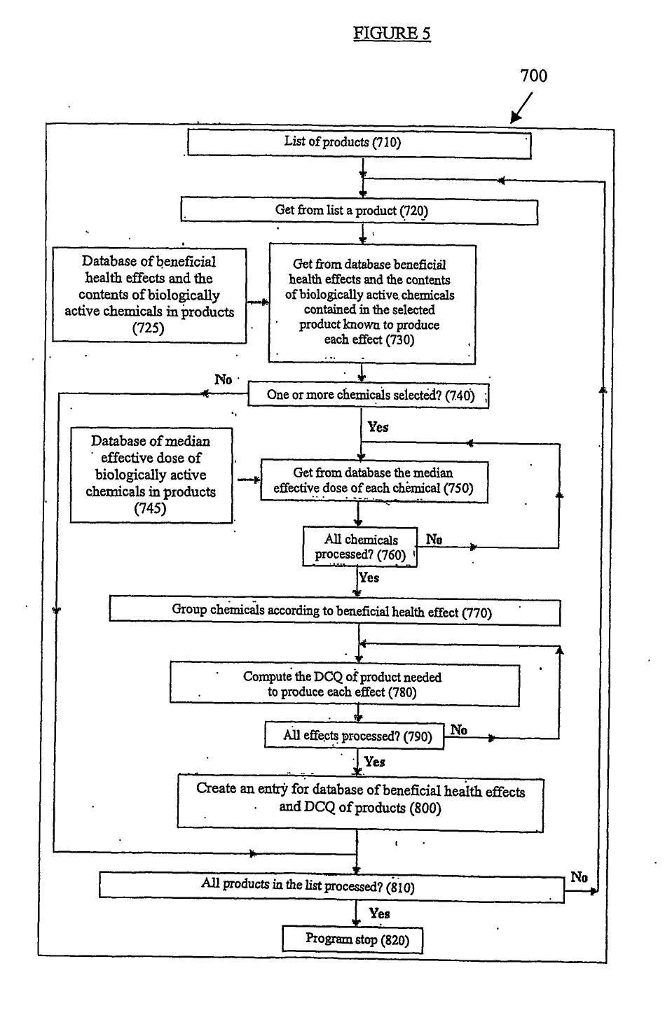

FIG. 5 is a flow chart showing a method for generating a database of beneficial health effects and the DCQs of products;

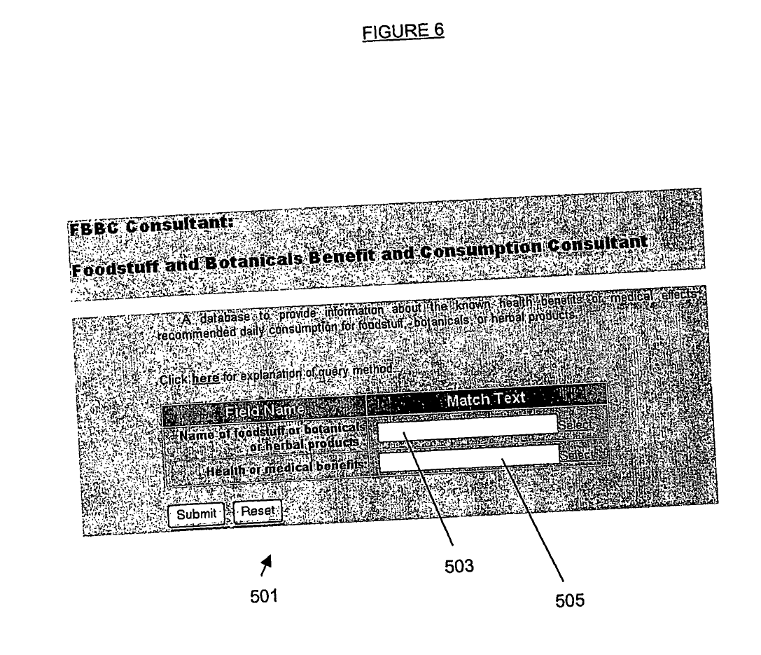

FIG. 6 shows a first example of a User Interface (UI) according to the invention;

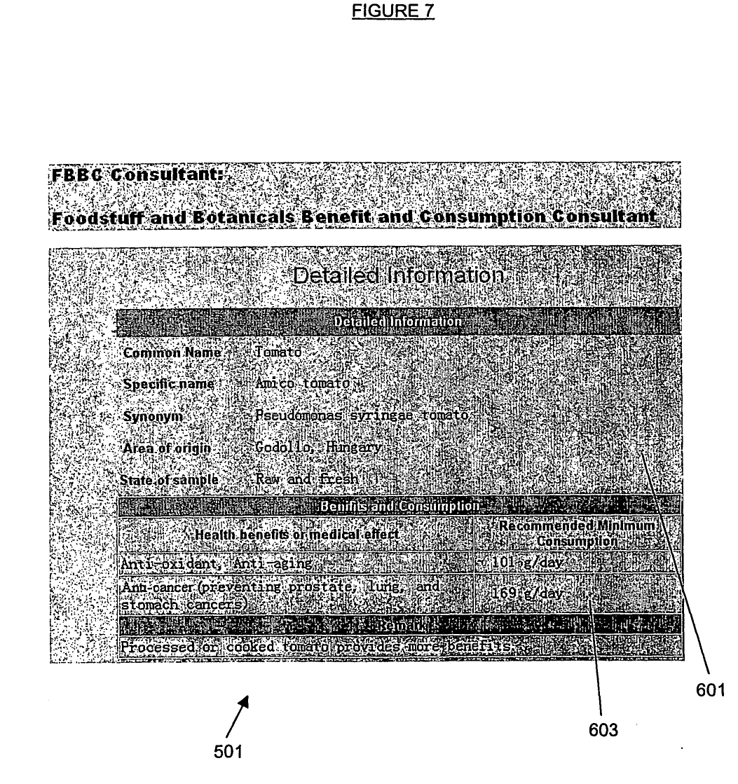

FIG. 7 shows the UI of FIG. 6 when a specific product name search has been undertaken by the user;

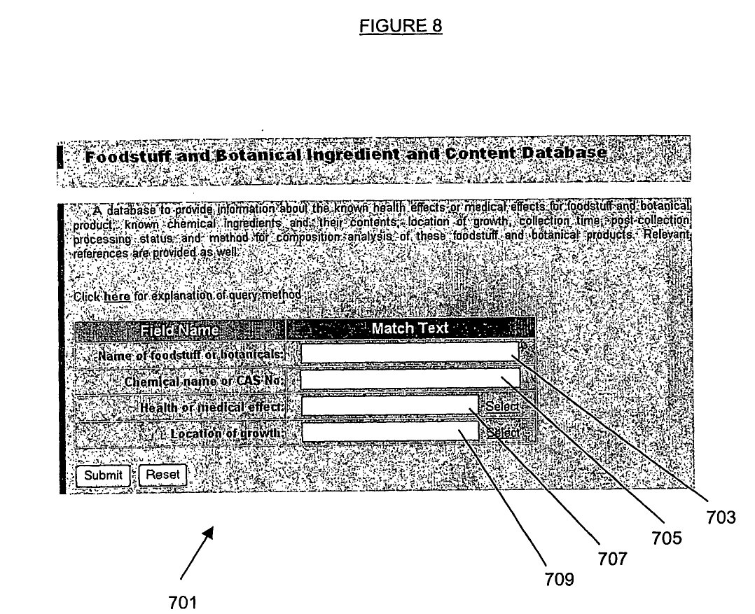

FIG. 8 shows a second example of a User Interface (UI) according to the invention;

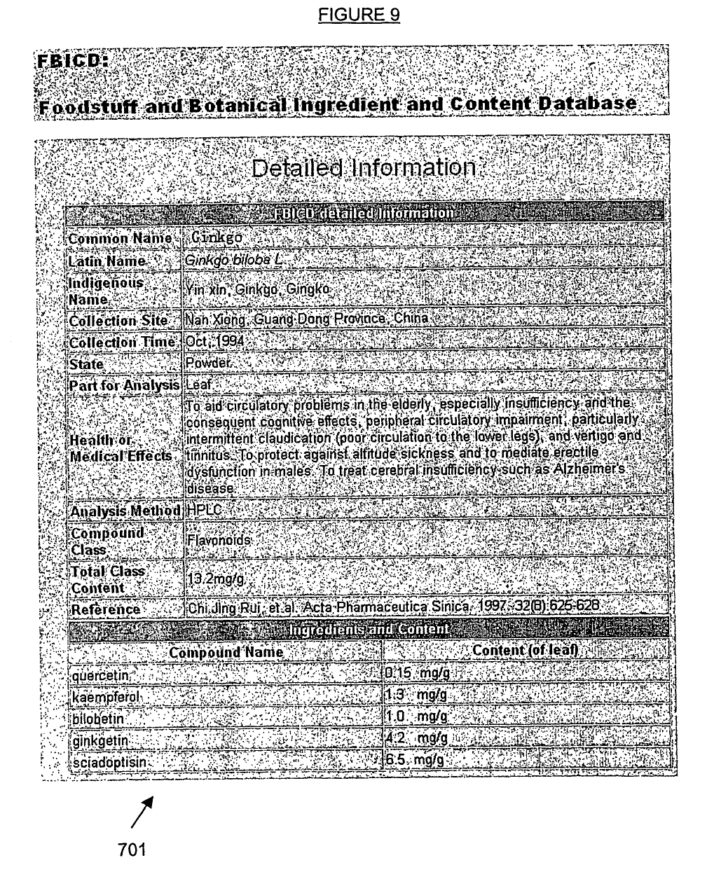

FIG. 9 shows the UI of FIG. 8 when a specific product name search has been undertaken by the user;

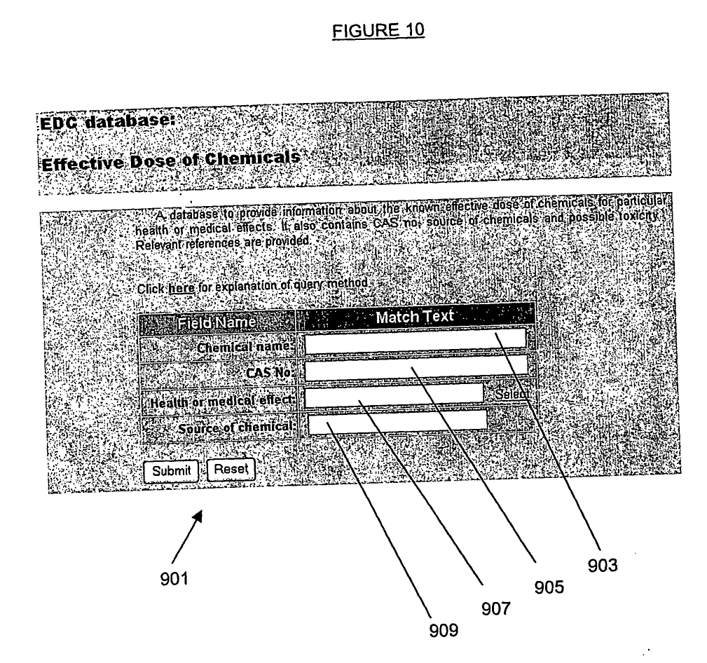

FIG. 10 shows a third example of a User Interface (UI) according to the invention; and

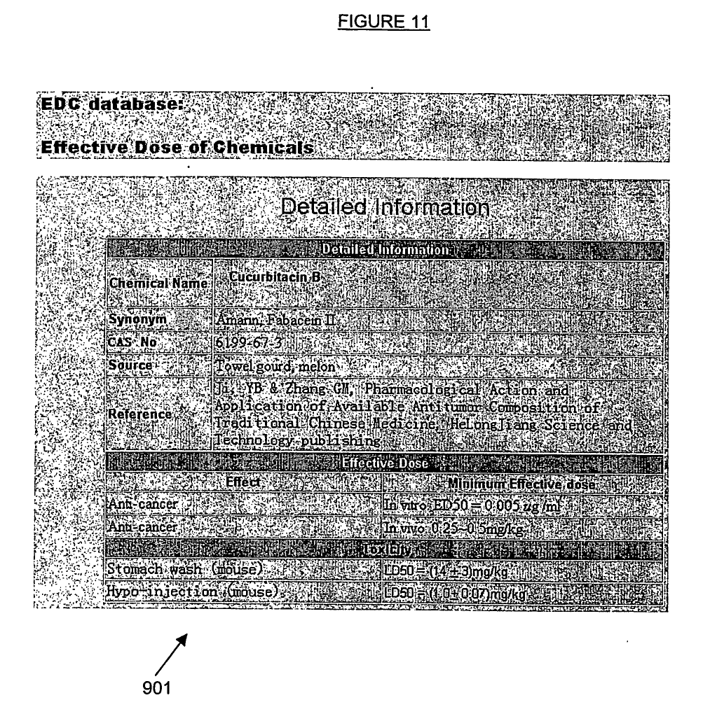

FIG. 11 shows the UI of FIG. 10 when a specific chemical name search has been undertaken by the user.

### FIG. 1 is a schematic illustration of apparatus on which the method of the invention may be implemented.

FIG. 1 shows a processor 10 for determining a health effect or health effects associated with a particular product and/or for determining product or products which provide a particular health effect. Database 12 is a database of products and associated health effects. Database 12 may also include further information, for example the biologically active chemical or chemicals in one or more of the products, which provide the particular health effect, the CAS number of those chemical(s) or the price of one or more of the products in the database. As will be seen below, the apparatus may also include one or more further databases containing such information.

Processor 10 has access to the database 12, in order to determine the health effect provided by a particular product or the product providing a particular health effect. A user may input a particular product at input 14, the processor 10 determines the health effect provided by that product from the database 12 and outputs that information to the user via output 16. Alternatively, the user may input a particular health effect at input 14, the processor 10 determines the product or products providing that health effect from the database 12 and outputs that information to the user via output 16. As will be seen below, the user may also enter other information at input 14, for example the CAS number of biologically active chemicals.

The method of operation will now be more fully described with reference to FIGS. 2 to 11.

FIG. 2 is a flow chart showing a method for determining the beneficial effect of a particular product or for determining the product or products required to produce a particular beneficial effect. The method illustrated in FIG. 2 may be used by an individual consumer.

Referring to FIG. 2, database 130 is a database of beneficial health effects of various products (including foodstuffs, botanicals and botanical products and herbs and herbal products) and the DCQs of those products. Database 135 is a database of synergistic and counterproductive effects of various products (including foodstuffs, botanicals and botanical products, herbs and herbal products and herb-drug combinations).

The process 100 begins at the start and, at the first step, the user may either select a particular product (step 110) or select a particular beneficial effect (step 150) to take the user through one of two routes through the FIG. 2 flow chart.

In the first case, at step 110, the user selects a particular product. This selection may be by scanning in the barcode of that product or by typing in the product name. As usual, the product may be a foodstuff, a herbal product or a botanical product. Common names, Latin names, brand names or other titles may be acceptable.

The user then moves to step 120. At that step, the selected name is used to search databases 130 and 135. For products that match the particular inputted name, information is obtained regarding a) the beneficial health or medical effects, b) the synergistic effects or counterproductive effects when combined with other products and c) DCQs of the selected product required to produce each effect.

The user then moves to step 140. At that step, information regarding the beneficial health or medical effects, synergistic effects or counterproductive effects, and DCQ of the selected product may be exported to the user.

In the second case, at step 150, the user selects a particular beneficial health or medical effect.

The user then moves to step 160. At that step, the selected effect is used to search databases 130 and 135. For the particular beneficial effect selected, information is obtained regarding a) the product or products known to produce the effect, b) the DCQ required of each product to produce the effect and c) synergestic effects or counterproductive effects when combined with other products.

The user then moves to step 170. At that step, information regarding the beneficial health or medical effects, synergistic effects or counterproductive effects, and DCQ of the selected product may be exported to the user.

FIG. 3 is a flow chart showing a method for determining the beneficial effect of a particular product or for determining the product or products required to produce a particular beneficial effect together with price information relating to the products, which information may be loaded by a retailer or manufacturer.

Referring to FIG. 3, database 215 is a database of beneficial health effects of various products (including foodstuffs, botanicals and botanical products and herbs and herbal products) and the DCQs of those products. Database 215 is analogous to database 130 in the flow chart of FIG. 2. Database 216 is a database of synergistic and counterproductive effects of various products (including foodstuffs, botanicals and botanical products, herbs and herbal products and herb-drug combinations). Database 216 is analogous to database 135 in the flow chart of FIG. 2. 225 and 235 are product lists including products selected by the user (typically a retailer or manufacturer).

The process 200 begins at one of three different locations. The first location (step 210) is the starting location for a retailer or manufacturer to load information. The second and third starting locations (steps 310 and 410 respectively) are two separate starting locations for consumers, retailers and manufacturers to obtain information.

In the first case, at step 210, the user selects whether or not to load the price of products (as usual, including foodstuffs, botanicals and herbal products) on user-selected product list 225.

If the price is not to be loaded, then the user moves to step 220. At that step, information in databases 215 and 216 on those products on the user-selected product list 225 is loaded into database 240. Database 240 is therefore a database including the beneficial effects of the products on list 225, the DCQs of the products on list 225 and the synergistic and counterproductive effects of the products on list 225.

If, on the other hand, the price is to be loaded, then the user moves to step 230. At that step, as with step 220, information in databases 215 and 216 on those products on the user-selected product-list 235 is loaded into database 240. In addition, however, at step 230, information in databases 215 and 216 on those products on the user-selected product list 235 is loaded into price list 250. Database 250 holds information on the price of products (including foodstuffs, botanicals and herbal products) from the retailer or manufacturer. Thus, after step 230, price list 250 holds price information for those products on list 235.

In the second case, the user begins process 200 at step 310. At that step, the user selects a particular product. As with FIG. 2, this selection may be by scanning in the barcode of that product or by typing in the product name. As usual, the product may be a foodstuff, a herbal product or a botanical product. Common names, Latin names, brand names or other titles may be acceptable.

The user then moves to step 320. At that step, the selected name is used to search database 240. For products that match the particular inputted name, information is obtained regarding a) the beneficial health effects, b) the synergistic effects or counterproductive effects when combined with other products and c) DCQs of the selected product required to produce each effect.

The user then moves to step 330. At that step, the user is asked whether price information is required. If price information is not required, then the user moves directly to step 350, which is described below. If price information is required, then the user moves to step 340. At that step, information on the price of selected products is obtained and the user moves on to step 350. At step 350, the user is asked whether all the user-selected products have been searched. If “No”, the user repeats steps 320, 330 and 340 for further products. If “Yes”, then the user moves to step 360.

At step 360, the user is asked whether or not there is more than one user-selected foodstuffs, botanicals, or herbal products. If “No” the user moves directly on to step 380, as will be described below. If “Yes”, the user moves to step 370.

At step 370, several pieces of information are determined:
1) The product with the smallest required DCQ;
2) The product with the lowest price (assuming that price information has been loaded by the retailer or manufacturer); and
3) The DCQ of each product if an equal amount of all the user-selected products are to be taken by the consumer.

That information is computed by the following formulae:

Assuming that there are N products selected by the user, DCQᵢ is the daily consumption quantity (in grams) of the i-th product, required to produce a beneficial health effect and Pᵢ is the price of the i-th product, required to produce a beneficial health effect. i=1, 2, 3, . . . , N.

The product with the smallest required daily consumption quantity is the one with smallest DCQᵢ (item 1).

The product with the lowest price is the one with smallest DCQᵢ×Pᵢ (item 2).

The DCQ of each product if an equal amount of all the user-selected products are to be taken (item 3) is given by:
DCQ=1/[Σ_{Sum of products (i=1, . . . , N)} 1/DCQᵢ]

The user then moves on to step 380. At that step, information regarding the beneficial health effect, DCQ of the selected products and their synergistic or counterproductive effects when combined with other products may be exported to the user.

In the third case, the user begins process 200 at step 410. This third route through the flow chart of FIG. 3 is analogous to the second route as described above, but for a known beneficial health effect rather than a known product. At step 410, the user selects a particular beneficial health effect. The user then moves to step 420. At that step, the selected beneficial effect is used to search database 240. For entries that match the particular inputted effect, information is obtained regarding a) the product or products known to provide the effect and b) the DCQ for each product required to produce the effect.

The user then moves to step 430. At that step, the user is asked whether price information is required. If price information is not required, then the user moves directly to step 450, which is described below. If price information is required, then the user moves to step 440. At that step, information on the price of selected products is obtained and the user moves on to step 450. At step 450, the user is asked whether all the user-selected beneficial health effects have been searched. If “No”, the user repeats steps 420, 430 and 440 for further beneficial effects. If “Yes”, the user moves to step 460.

At step 460, the information regarding the beneficial health effect and DCQ of the selected product is exported to the user. The user then moves to step 470. At that step, the user is asked whether more than one product is to be selected.

If “No”, the user moves directly to step 490. If “Yes”, the user moves to step 480. At that step, the DCQ of each product (if an equal amount of each product is to be taken) is calculated according to the calculation described above in relation to step 370. The user then moves to step 490.

At step 490, information regarding the beneficial health effect, DCQ of the selected products and their synergistic or counterproductive effects when combined with other products may be exported to the user.

FIG. 4 is a flow chart showing a method enabling use of a weighing device, having an electronic display panel and connected to a computer, to display information about whether or not a product on the device is sufficient to produce a particular beneficial health effect.

Referring to FIG. 4, database 515 is a database of beneficial health effects of various products (including foodstuffs, botanicals and botanical products and herbs and herbal products) and the DCQs of those products. Database 540 is a similar database (of beneficial health effects of various products and the DCQs of those products) from a retailer or manufacturer.

The process 500 begins at one of two different locations. The first location (step 510) is the starting location for a retailer or manufacturer to load information. The second location (step 610) is the starting location for consumers, retailers and manufacturers to use a weighing device to obtain information as well as to weigh a particular product 525 is a product list including products selected by the user (typically a retailer or manufacturer) and 535 is a product list including products selected by the user (typically a retailer or manufacturer) together with price information.

In the first case, at step 510, the user selects whether or not to load the price of products (as usual, including foodstuffs, botanicals and herbal products) on user-selected product list 525 or 535.

If the price is not to be loaded, then the user moves to step 520. At that step, information in database 515 on those products on the user-selected product list 525 is loaded into database 540. Database 540 is therefore a database including the beneficial effects of the products on list 525 and the DCQs of the products on list 525.

If, on the other hand, the price is to be loaded, then the user moves to step 530. At that step, as with step 520, information in database 515 on those products on the user-selected product list 535 is loaded into database 540. In addition, however, at step 530, information in database 515 on those products on the user-selected product list 535 is loaded into price list 550. Database 550 holds information on the price of products (including foodstuffs, botanicals and herbal products) from the retailer or manufacturer. Thus, after step 530, price list 550 holds price information for those products on list 535.

In the second case, the user begins process 500 at step 610. At that step, a particular product is put on a weighing device (not shown). The weighing device has an electronic display and is connected to a computer having a storage device holding databases 540 and 550. The user then moves to step 615 where the user selects the name of the product on the weighing device. The user may select the product name by typing in the product name, by selecting the product name from a list or by scanning in the barcode provided on the product.

The user then moves to step 620. At that step, the selected name is used to search database 540. For products that match the particular inputted name, information is obtained regarding a) the beneficial health effects and b) the DCQ of each product required to produce each effect. The user then moves to step 625. At that step, the user is asked whether price information is required. If price information is not required, then the user moves directly to step 635, which is described below. If price information is required, then the user moves to step 630. At that step, information on the price of selected products is obtained from price list 550 and the user moves on to step 635.

At step 635, the list of beneficial health effects of the product is displayed to the user, preferably via the display panel on the weighing device.

Then, at step, 640, the user is asked to select a beneficial health effect from the displayed list. Then, at step 645, the user is asked to select or input the number of days for consumption of the product on the weighing device.

At step 650, the consumption quantity of the product required to produce the selected beneficial effect for the inputted number of days is calculated as follows.

Assuming that the number of days for consumption is n and the daily consumption quantity (in g) of the product required to produce a beneficial health effect is DCQ, then the consumption quantity for the number of days is CQ=n×DCQ.

If W is the weight in grams of the product on the weighing device, the amount of product on the weighing device is sufficient to produce the selected beneficial health effect if W/CQ 1. The amount is not sufficient if W/CQ<1.

The user then moves to step 655. At that step, if W/CQ 1, the fact that the product is sufficient to produce the selected beneficial effect is displayed to the user, preferably on the electronic display panel of the weighing device. If, on the other hand, W/CQ<1, the fact that the product is insufficient to produce the selected beneficial effect is displayed to the user, preferably on the electronic display panel of the weighing device.

The user then moves to step 660. At that step, if more than one beneficial effect has been displayed to the user at step 635, the user is asked whether to select another effect. If the user opts to select another effect, the user repeats steps 640, 645, 650 and 655 for that effect. If the user does not opt to select another effect, or if only one effect was displayed to the user at step 635, the process 500 stops.

FIG. 5 is a flow chart showing a method for generating a database of beneficial health effects and the DCQs of products.

Referring to FIG. 5, database 725 is a database of beneficial health effects of various products and the contents of biologically active chemicals in those products. Database 725 can be generated from a literature search. It contains information on:
experimentally determined health-effects, medically-benefiting effects, or therapeutic effects of various products;
the known chemical ingredients and their contents in these products;
the CAS number of those chemical ingredients;
the chemical class and content of chemical class in these products;
the location of growth, collection time, post-collection processing status and methods of experimental analysis of the products;
references to relevant scientific publications.

Each piece of information in this database can be retrieved by selecting or typing the name of a product, the beneficial health effect, the name of a constituent chemical, the name of a chemical class, the parts of a plant or animal and/or method of experimental analysis. For convenience, searches via English common name, indigenous name, and Latin name are all supported. To support the link with a database of effective dosage of biologically active chemicals, search of a chemical via the CAS number is also supported.

Database 745 is a database of median effective doses of biologically active chemicals in various products. Database 745 can be generated from a literature search. It contains information on:
the experimentally determined beneficial health effects of chemicals in various products;
the experimentally determined median effective dose of the corresponding chemicals;
the CAS number of each of these chemicals; and
plants and animals that contain each of these chemicals.

Each piece of information in the database can be accessed by typing or selecting the CAS number of a chemical, the name of a chemical, the name of a plant or animal and/or the beneficial effect. For convenience, searches via English common name, indigenous name and Latin name are all supported.

The process 700 begins at step 710. At that step, a list of products (including foodstuffs, botanicals and botanical products and herbs and herbal products) is provided as an input file for generating the corresponding entries in the database.

The user then moves to step 720. At that step, the name of each product in the list provided at step 710 is obtained. Also obtained is information regarding 1) the part of the plant or animal, 2) the place of growth and 3) the season or time of collection or harvest.

At step 730, the selected product name, the part of plant or animal, the place of growth or the season or time of collection or harvest is used to search database 725 to obtain the following information about the product: a) the beneficial health effect(s) of the biologically active chemicals contained in the product; b) the content of each chemical in the product; and c) the CAS (Chemical Abstract Service) number of each chemical.

The user then moves to step 740. At that step, the user is asked whether one or more chemicals are selected from database 725. If no chemical is selected, then the user moves directly to step 810, which is described below.

If one or more chemicals are selected, then the user moves to step 750. At that step, the CAS number or the name of each selected chemical is used to search database 745 to retrieve information on the median effective dose of the selected chemical.

The user then moves to step 760. At that step, the user is asked whether all the selected chemicals have been searched. If not all the selected chemicals have been searched, then steps 750 and 760 are repeated. If all the selected chemicals have been searched, then the user moves to step 770.

At step 770, the chemicals are divided into groups according to the beneficial health effect, each group containing chemicals having the same beneficial health effect.

At the next step 780, the DCQ of the selected product required to produce each beneficial effect is calculated as follows.

There are M chemicals contained in the selected product known to produce a beneficial health effect. The content of each of these chemicals in the selected product can be represented by Cᵢ in units of mg/g. The median effective dose of each of these chemicals can be represented by EDᵢ in units of mg. Here i is the index of the chemicals: i=1, 2, 3, . . . , N. The DCQ (in grams) of the selected product needed to produce each beneficial effect can be given by:
DCQ=1/[Σ_{Sum of chemicals (i=1, . . . , N)} Cᵢ/EDᵢ]

The user then moves to step 790. At that step, the user is asked whether the DCQ for every beneficial health effect has been computed. If not all the DCQs have been computed, then steps 780 and 790 are repeated. If the DCQs have been computed, then the user moves to step 800.

At step 800, an entry is created for the database of beneficial health effects and DCQs of products. This entry contains information on:
the name of a product;
each beneficial health effect of the product;
the part of plant or animal;
the place of growth;
the season or time of collection or harvest;
the name, CAS number and content of every biologically active chemical in the product known to produce each effect; and
the Latin name and indigenous name of the product.

The next step is step 810. At that step, the user is asked whether all the products in the list 710 have been processed. If not all the products in list 710 have been processed, then steps 720 to 800 of the process are repeated.

If all the products in list 710 have been processed, the process 700 stops. FIGS. 6 and 7 show a first example of a User Interface (UI) according to the invention.

The software used in this example, and shown in FIGS. 6 and 7, is termed the FBBC. Consultant (Foodstuff Botanical Benefit Consumption Consultant) and this provides information about the beneficial effects of products and the DCQs of those products required to achieve each effect. FBBC currently contains information for 89 fruit species, 74 vegetable species, 61 animal species, 152 foodstuff products (including agricultural products like rice, beverages, oil products, processed foods, supplements etc.) and 2,845 herbs and herbal products, although effort is being made to collect information for additional fruits, vegetables, foodstuffs of other classes, botanical products and herbal products.

FIG. 6 shows the User Interface 501 of the FBBC. With this User Interface, the user can determine the beneficial effect of a particular product (input 503) or can determine the product or products required to produce a particular beneficial effect (input 505). This is in accordance with the two possible routes through the flow chart shown in FIG. 2.

FIG. 7 shows the User Interface 501 of the FBBC when the user has selected the vegetable product “tomato” produced in Godollo, Hungary in the input 503. Product details are shown in the top portion 601 of the UI. Details of beneficial effects are shown in the lower portion 603 of the UI. In this case, we see that the tomato is known to contain antioxidant and anti-aging ingredients and ingredients with cancer protection properties¹⁸. The DCQs to achieve these particular effects are also indicated.

FIGS. 8 and 9 show a second example of a User Interface (UI) according to the invention.

The software used in this example, and shown in FIGS. 8 and 9, is termed the FBICD (Foodstuff and Botanical Ingredient and Content Database). The FBICD is a database providing information on, inter alia:
experimentally determined beneficial health, medical and therapeutic effects of various foodstuffs, botanicals, herbs and herbal products;
known chemical ingredients and their contents in those foodstuffs, botanicals, herbs and herbal products;
the CAS number of those chemical ingredients;
location of growth, collection time, post-collection processing status and methods of experimental analysis of the foodstuffs, botanicals, herbs and herbal products; and
references to relevant scientific publications.

FBICD currently contains information for 50 fruits, 46 vegetables, and 2575 herbs and herbal products and effort is being made to collect information for additional fruits, vegetables, foodstuffs of other classes, botanicals, and herbal products.

FIG. 8 shows the User Interface 701 of the FBICD. With this User Interface, the user can retrieve information by selecting or typing the name of a foodstuff, botanical, herb or herbal product (input 703), the chemical name or CAS number of a constituent chemical (input 705), the beneficial health or medical effect (input 707) or the location of growth (input 709). For convenience, searches via the English common name, the indigenous name, or the Latin name are supported. In addition, searches of a chemical via the CAS number are also supported.

FIG. 9 shows the User Interface 701 of the FBICD when the user has selected the herb product “ginkgo” produced in Guang Dong province, China in the input 703.

Ginkgo biloba is a dioecious tree with a history of use in traditional Chinese medicine. Although the seeds are most commonly employed in traditional Chinese medicine, in recent years standardised extracts of the leaves have been widely sold as a phyto-medicine in Europe and as a dietary supplement in the United States. The primary active constituents of the leaves include flavonoid glycosides and unique diterpenes known as ginkgolides; the latter are potent inhibitors of platelet activating factor. Clinical studies have shown that ginkgo extracts exhibit therapeutic activity in a variety of disorders including Alzheimer's disease, failing memory, age-related dementia, poor cerebral and ocular blood flow, congestive symptoms of premenstrual syndrome, and the prevention of altitude sickness. Due in part to its potent antioxidant properties and ability to enhance peripheral and cerebral circulation, ginkgo's primary application lies in the treatment of cerebro vascular dysfunction and peripheral vascular disorders¹⁹.

FIGS. 10 and 11 show a third example of a User Interface (UI) according to the invention.

The software used in this example, and shown in FIGS. 10 and 11, is termed the EDC (Effective Dose of Chemicals) Database. This database provides information on experimentally determined median effective doses of biologically active chemicals in various products. The database is organised so as to allow ease of access to the information. The database also includes information on the CAS number of each chemical, a list of plants and animals that contain each chemical and references to relevant scientific publications. EDC currently contains information about the effective dose of 2,153 biologically active chemicals.

FIG. 10 shows the User Interface 901 of the EDC. With this User Interface, the user can retrieve information by selecting or typing a chemical name (input 903), the CAS number of a chemical (input 905), the beneficial effect (input 907) or the name of a plant or animal source of chemical (input 909). For convenience, searches via the English common name, the indigenous name, or the Latin name are supported.

FIG. 11 shows the User Interface 901 of the ECD when the user has selected the chemical “cucurbitacin B” in the input 903. The User Interface shows the beneficial effects of cucurbitacin B, the minimum effective dose and the toxicity.

### REFERENCE TO PUBLICATIONS

1. “Botanicals in cancer chemoprevention”, E. J. Park and J. M. Pezzuto. Cancer Metastasis Review 21, 231-255. (2002); “Vegetables, fruits and cancer prevention: a review”, K. A. Steinmetz, and J. D. Potter, J. Am. Diet. Assoc. 96, 1027-1039 (1996); “Bioactive compounds in foods: their role in the prevention of cardiovascular disease and cancer”, P. M. Kris-Etherton et. Al. Am. J. Med. 113 suppl 98, 71S-88S (2002); “Tomatoes and cardiovascular health”, J. K. Wilcox, G. L. Catignani, S. Lazarus, Crit. Rev. Food Sci. Nutr. 43, 1-18 (2003); and “Health effects of vegetable and fruits: assessing mechanisms of action in human experimental studies”, J. W. Lampe, Am. J. Clin. Nutr. 70 suppl. 475S-490S (1999).
2. “The new face of traditional Chinese medicine”, D. Normile, Science 299, 188-190 (2003); “Traditional Chinese medicine: an approach to scientific proof and clinical validation”, R. Yuan, and Y. Lin, Pharmacology and Therapeutics 86, 191-198 (2000); “Therapeutic plants of Ayurveda: a review of selected clinical and other studies for 166 species”, S. Khan, and M. J. Balick, J Altern Complement Med. 7, 405-515 (2001); “Siddha medicine: an overview”, B. V. Subbarayappa, Lancet. 350, 1841-1844 (1997); “American Indian medicine and contemporary health problems. II. Powerful medicinal plants in traditional Iroquois culture”, J. W. Herrick, New York State J Med. 78, 979-987 (1978); and “Traditional African medicine: theory and pharmacology explored” Trends Pharmacol Sci. 20, 482-485 (1999)
3. “Trends in alternative medicine use in the United states, 1990-1997”, D. M. Eisenberg et. al., J. Am. Med. Assoc. 280, 1569-1575 (1998); “Herbal medicines and preoperative care”, M. K. A. Lee, J. Moss, and C. S. Yuan, J. Am. Med. Assoc. 286, 208-216 (2001); and “Comments on complementary and alternative medicine in Europe” D. Reilly, J Altern Complement Med. 7 Suppl 1:S23-S31 (2001).
4. “Health effects of vegetable and fruits: assessing mechanisms of action in human experimental studies”, J. W. Lampe, Am. J. Clin. Nutr. 70 suppl. 475S-490S (1999); “Herbal medicines and perioperative care”, M. K. A. Lee, J. Moss, and C. S. Yuan, J. Am. Med. Assoc. 286, 208-216 (2001);
5. “More Americans are eating “5 a day” but intakes of dark green and cruciferous vegetables remain low”, C. S. Johnston, C. A. Taylor, and J. S. Hampl, J. Nutr. 130, 3063-3067 (2000); and “Fruit, vegetables, and cancer prevention: a review of the epidemiological evidence”, G. Block, B. Patterson, and A. Subar, Nutr. Cancer 18, 1-29 (1992).
6. “Dietary supplements and functional foods: 2 sides of a coin?”, C. H. Halsted, Am. J. Clin. Nutr. 77, suppl, 1001S-1007S (2003); and “Safety evaluation of functional ingredients”, C. L. Kruger and S. W. Mann, Food Chem. Toxicol. 41, 793-805 (2003).
7. “Dose-response characteristics of uterine responses in rats exposed to estrogen agonists”, H. A. Barton, M. E. Anderson, and B. C. Allen, Regul Toxicol. Pharmacol. 28, 133-149 (1998); and “Database resources of the National Center for Biotechnology”, D. L. Wheeler et. al., Nucleic Acids Res. 31, 28-33 (2003).
8. “Handbook of composition and pharmacological action of commonly-used traditional Chinese medicine”, K. T. Huang et. al. (1997).
9. “The effect of red wine and its components on growth and proliferation of human oral squamous carcinoma cells”, T. M. Elattar and A. S. Virji, Anticancer Res. 19, 5407-5414 (1999).
10. “Phenol antioxidant quantity and quality in foods: fruits”, J. A. Vinson, X. Su, L. Zubik, and P. Bose, J. Agric. Food Chem. 49, 5315-5321; “Antioxidant and antiproliferative activities of common fruits?”, J. Sun, Y. F. Chu, X. Wu, and R. H. Liu, J. Agric. Food Chem. 50, 7449-7454 (2002); “Antioxidant and antiproliferative activities of common vegetables”, Y. F. Chu, J. Sun, X. Wu, and R. H. Liu, J. Agric. Food Chem. 50, 6910-6916 (2002); “Five volatile compounds—a first comparative study”, L. Grison-Pige, M. Hossaert-McKey, J. M. Greeff, J-M. Bessiere, Phytochemistry 61, 61-71 (2002); and “Study on the composition of the volatile fraction of Hamamelis virginiana”, R. Engel, M. Gutmann, C. Hartisch, H. Kolodziej, and A. Nahrstedt, Planta Medica 64, 251-258 (1998).
11. “Synergy and other interactions in phytomedicines”, Williamson, Phytomedicine 8, 401-409 (2001); and “Antioxidant properties of fruit and vegetable juices: more to the story than ascorbic acid”, Leonard et. al., Ann Clin Lab Sci. 32,193-200 (2002),
12. “Acute, dose-dependent cognitive effects of Ginkgo biloba, Panax ginseng and their combination in healthy young volunteers: differential interactions with cognitive demand”, Scholey and Kennedy, Hum. Psychopharmacol., 35-44 (2002).
13. “Do attitudes toward and beliefs about complementary medicine affect treatment outcomes?”, Lewith et. al., Am J Public Health.92, 1604-6 (2002).
14. “Drug interactions between herbal and prescription medicines”, Williamson E M. Drug Saf. 26, 1075-92 (2003); and “Drug-drug, drug-dietary supplement, and drug-citrus fruit and other food interactions: what have we learned?”, Huang S M, Lesko L J. J Clin Pharmacol. 44, 559-69 (2004).
15. “Synergy and other interactions in phytomedicines”, Williamson, Phytomedicine 8, 401-409 (2001); and “Synergy in a medicinal plant: antimicrobial action of berberine potentiated by 5′-methoxyhydnocarpin, a multidrug pump inhibitor, Stermitz et. al., Proc Nati Acad Sci USA. 97, 1433-7 (2000).
16. “The importance of pharmacological synergy in psychoactive herbal medicines”, Spinella, Altern Med Rev. 7, 130-7 (2002).
17. “Synergy in a medicinal plant: antimicrobial action of berberine potentiated by 5′-methoxyhydnocarpin, a multidrug pump inhibitor, Stermitz et. al., Proc Natl Acad Sci USA. 97, 1433-7 (2000).
18. “Change in carotenoids and antioxidant vitamins in tomato as a function of varietal and technological factors”, A. A. Abushita, H. G. Daood, and P. A. Biacs, J. Agric. Food Chem. 48, 2075-2081 (2000); and “Chemistry, distribution, and metabolism of tomato carotenoids and their impact on human health”, F. Khachik et. al., Exp. Biol. Med. (Maywood), 227, 845-851 (2002).
19. “Efficacy, safety, and use of ginkgo biloba in clinical and preclinical applications”, D. J. Mckenna, K. Jones, and K. Hughes, Altern. Ther. Health. Med., 7, 70-86, 88-90 (2001); “Ginkgo biloba extract: review of CNS effects”, L. L. Ponto, and S. K. Schultz, Ann. Clin. Psychiatry 15, 109-119 (2003);

1-32. (canceled)

33. Apparatus for determining health effect of a selected product, or product(s) providing a selected health effect, the apparatus comprising:
a database of products and associated health effects, the database comprising information on synergistic effects of some or all of the products in the database and counterproductive effects of some or all of the products in the database, when combined with another product or products;
an input for a user to input the selected product or selected health effect;
a processor for determining health effect of the selected product from the database and/or for determining product(s) from the database providing the selected health effect; and
an output for outputting information to the user.

34. Apparatus according to claim 33 further comprising weighing scales connected to the input, for weighing the selected product.

35. Apparatus according to claim 34 wherein the weighing scales comprise a user display connected to the output.

36. Apparatus according to claim 33 further comprising a barcode scanner connected to the input, for scanning a barcode of the selected product.

37. Apparatus according to claim 33 wherein the database comprises at least one of the following:
a) information on the daily consumption quantity for some or all of the products in the database, required to produce the health effect;
b) price of some or all the products in the database; or
c) information on the biologically active chemical or chemicals producing the health effect in some or all the products in the database.

38. Apparatus according to claim 37 wherein the database comprises information on the CAS number of biologically active chemical(s) in the products.

39. Apparatus according to claim 37 wherein the database comprises information on the content of biologically active chemical(s) in each product.

40. Apparatus according to claim 33 wherein the processor is a computer.

41. Apparatus according to claim 40 wherein the database is stored on a storage device for use with the computer.

42. Apparatus according to claim 40 wherein the database is stored on the computer hard drive.

43. Apparatus according to claim 40 wherein the input is a computer user interface.

44. Apparatus according to claim 40 wherein the output is a computer user interface.

45. A method for determining health effect of a selected product, or product(s) providing a selected health effect, the method comprising the steps of:
providing a database of products and associated health effects, the database comprising information on synergistic effects of some or all of the products in the database and counterproductive effects of some or all of the products in the database, when combined with another product or products;
inputting the selected product or selected health effect into a user input;
determining health effect of the selected product from the database, or product(s) from the database providing the selected health effect; and
outputting information to the user.

46. A method according to claim 45 wherein the step of inputting comprises at least one of the following:
a) selecting the product or health effect from a pre-determined list;
b) typing the health effect or product name;
c) scanning a product barcode;
d) inputting the weight of a product;
e) inputting a chemical name;
f) inputting a chemical CAS number; or
g) inputting information on the source of the product.

47. A method according to claim 46 wherein inputting the weight of a product is via weighing scales connected to the input.

48. A method according to claim 45 wherein the step of providing a database of products and associated health effects, comprises providing a database including at least one of the following:
a) information on the daily consumption quantity for some or all of the products in the database, required to produce the health effect;
b) price of some or all the products in the database;
c) information on the biologically active chemical or chemicals producing the health effect in some or all the products in the database;
d) information on the CAS number of biologically active chemical(s) in the products; or
e) information on the content of biologically active chemical(s) in each product.

49. A method of generating a database of products and associated health effects, comprising the steps of:
a) providing a first database of products and the contents of biologically active chemicals in those products;
b) providing a second database of biologically active chemicals and median effective doses of those chemicals required to provide particular health effects;
c) selecting a product P from the first database;
d) from the first database, determining a biologically active chemical B in product P and the content C of biologically active chemical B in product P;
e) from the second database, determining the median effective dose D of biologically active chemical B to provide a particular health effect H;
f) determining the daily consumption quantity DCQ of product P required to provide health effect H, from the results at steps d) and e);
g) inputting product P, daily consumption quantity DCQ, biologically active chemical B, content C, median effective dose D and health effect H into a third database; and
h) repeating one or more of steps c) to g).

50. Apparatus according to claim 33 wherein the database is generated by the method comprising the steps of:
a) providing a first database of products and the contents of biologically active chemicals in those products;
b) providing a second database of biologically active chemicals and median effective doses of those chemicals required to provide particular health effects;
c) selecting a product P from the first database;
d) from the first database, determining a biologically active chemical B in product P and the content C of biologically active chemical B in product P;
e) from the second database, determining the median effective dose D of biologically active chemical B to provide a particular health effect H;
f) determining the daily consumption quantity DCQ of product P required to provide health effect H, from the results at steps d) and e);
g) inputting product P, daily consumption quantity DCQ, biologically active chemical B, content C, median effective dose D and health effect H into a third database; and
h) repeating one or more of steps c) to g).

51. A method according to claim 45 wherein the database is generated by the method comprising the steps of:
a) providing a first database of products and the contents of biologically active chemicals in those products;
b) providing a second database of biologically active chemicals and median effective doses of those chemicals required to provide particular health effects;
c) selecting a product P from the first database;
d) from the first database, determining a biologically active chemical B in product P and the content C of biologically active chemical B in product P;
e) from the second database, determining the median effective dose D of biologically active chemical B to provide a particular health effect H;
f) determining the daily consumption quantity DCQ of product P required to provide health effect H, from the results at steps d) and e);
g) inputting product P, daily consumption quantity DCQ, biologically active chemical B, content C, median effective dose D and health effect H into a third database; and
h) repeating one or more of steps c) to g).

52. A method for determining health effect of a selected product, or product(s) providing a selected health effect, the method comprising the steps of:
user computer means receiving an input on the selected product or selected health effect;
host computer means determining, from a database of products and associated health effects, health effect of the selected product, or product(s) providing the selected health effect, the database comprising information on synergistic effects of some or all of the products in the database and counterproductive effects of some or all of the products in the database, when combined with another product or products; and
user computer means outputting information to a user.
